(19) United States
(12) Patent Application Publication
(10) Pub. No.: US 2016/0371957 A1
(43) Pub. Date: Dec. 22, 2016

(54) METHOD AND SYSTEM FOR STRUCTURAL HEALTH MONITORING

(71) Applicant: MC10, INC., Lexington, MA (US)

(72) Inventors: Roozbeh GHAFFARI, Cambridge, MA (US); Milan RAJ, Natick, MA (US); Bryan MCGRANE, Cambridge, MA (US)

(21) Appl. No.: 15/189,461

(22) Filed: Jun. 22, 2016

Related U.S. Application Data
(60) Provisional application No. 62/182,994, filed on Jun. 22, 2015.

(51) Int. Cl. G08B 21/18

(52) U.S. Cl. CPC G08B 21/182

(57) ABSTRACT

A system for monitoring physical and environmental conditions of an object can include one or more sensing devices affixed or mounted to the object. The sensing devices produce sensor data (e.g. motion, vibration, impact, temperature, stress and strain) that can be used to anticipate failure or for operation and/or maintenance purposes. The sensing devices can positioned on structures such as a building or an oil rig, on vehicles such as on airplanes, trains, ships and motor vehicles, and on moving devices such as wind turbines and draw bridges.

### CROSS-REFERENCE TO RELATED APPLICATIONS

This application claims any and all benefits as provided by law including benefit under 35 U.S.C. §119(e) of U.S. Provisional Application No. 62/182,994, filed Jun. 22, 2015, the contents of which are incorporated herein by reference in their entirety.

### STATEMENT REGARDING FEDERALLY SPONSORED RESEARCH

Not Applicable

### REFERENCE TO MICROFICHE APPENDIX

Not Applicable

### BACKGROUND

Technical Field of the Invention

The present invention is directed to methods and systems for monitoring physical and structural characteristics of one or more objects or things and using information about the physical and structural characteristics, and/or information derived therefrom to interact with control systems and components. More specifically, the system can include one or more sensors that detect a condition of one or more objects or things and use that information to change the operation of the object, system or a device in communication with the object or system.

Description of the Prior Art

Structural health monitoring (SHM) involves the application of sensors to monitor the condition of a component or device or system of an object (e.g., a structure or vehicle), for example, to monitor performance or to anticipate failure and to avoid harm. One of the disadvantages of the current systems is that the sensors tend to be large, bulky and limit the environment in which they can be operated.

### SUMMARY

The present invention is direct to systems that are adapted to monitor the condition (e.g. one or more aspects) of objects (e.g., structures, devices, vehicles, machinery, inanimate objects, and mechanical systems) to provide safety and performance monitoring as well as to improve the operation of systems that control aspects of the structures and objects. The present invention is directed to methods for monitoring environmental, physical, and structural conditions of a structure, object or system and using this information, either alone or in combination with other information, to influence or control, either directly or indirectly, one or more environmental factors or the operation of the system, structure or object.

In accordance with the invention, one or more objects, structures, devices, vehicles, machinery, inanimate objects and/or mechanical systems can be monitored by one or more sensing devices that indicate one or more conditions of a component or all of the structure, device, object and/or system. Object can be a vehicle, such as an automobile, an airplane, a train or a ship. The object can be a structure, such as, a building, an oil rig, a bridge, a tunnel, or a roadway. The object can be a structure having moveable components, such as, a wind turbine, a solar collector, a Draw Bridge, a dam, or a lock (waterway). The object can be a machine, such as, an elevator, an escalator, a crane or a hoist. The object can be a mechanical system, such as, a tram or ski lift.

The sensors can measure conditions including environmental, physical, and structural conditions, such as location, motion, vibration and impact of the object or a part of the object. The conditions can include the mechanical, electrical, physical, thermal and/or structural aspects of functions and/or operations of the object and/or its environment.

The sensed information about one or more objects can be collected and processed or analyzed and used as an input or used to select or modify an input to a control system that controls the object or the object's environment.

The system can utilize one or more algorithms to determine whether to modify the environment or the operation of a system or machine. For example, the algorithm can compare one or more parameters representative of one or more sensed conditions to a predefined threshold value (or range) and based on the outcome of the comparison, take no further action or proceed to interact with a control system to cause a change in the operating environment, the control system of the object or the operation of a machine associated with the object.

In accordance with some embodiments, the system, according to the algorithm, can include additional data as inputs to determine whether to interact with the control system to cause a change in the operating environment, the control system of the object or the operation of a machine associated with the object. The additional data can be data obtained from local and remote sources, such as environmental data (e.g., temperature, barometric pressure, humidity, wind velocity and wind direction, water velocity and water direction, water pH, and water chemical composition), time of day, ambient noise levels (e.g., levels of vibration or background noise), and ambient light levels (e.g., time of day, whether is sunny or cloudy outside). The system can process these data values using a logic tree or a set of rules to determine whether (or not) to interact with the control system to cause a change in the operating environment, the control system of the object or the operation of a machine associated with the object.

In accordance with some embodiments of the invention, the system, according to the algorithm, can determine a trend or a rate of change of one or more parameters and use the rate of change to predict an event time in the future when a specific parameter could exceed a threshold and require intervention. The system can also check the parameter one or more times prior to the event time to confirm that the rate of change of the specific parameter has not changed and the event time has not changed. Where the rate of change of the parameter has changed, the event time can be re-calculated using the new rate of change or as a function of two or more previously determined rates of change. In accordance with some embodiments of the invention, the system can interact with the control system prior to the event time, in order to cause a change in the environment or the operation of the machine prior to the specific parameter coming close to the threshold level.

In accordance with some embodiments, the system can determine a measure of degree to which the control system can change the operating environment, the control system of the object or the operation of a machine associated with the object. For example, the system can determine a change in direction and/or velocity of a motor vehicle. In accordance with some embodiments of the invention, the system can take into consideration the operational characteristics of the system or machine being controlled. In accordance with some embodiments of the invention, the system can provide information wirelessly about metrics, movement, and physical conditions to an internal control system, which in turn, can tune its mode of operation based on this information. For example, the environmental conditions (e.g., wind speed, direction and temperature) can be used to control the operation of a wind turbine to change the angle of attack of the turbine blades to avoid damage or injury in high winds. The system can use wind speed information (e.g., avg. speed as well as max speed, such as gust speed) to tune the angle of attack to optimize the turbine for energy production and safety.

These and other capabilities of the invention, along with the invention itself, will be more fully understood after a review of the following figures, detailed description, and claims.

### BRIEF DESCRIPTION OF THE FIGURES

The accompanying drawings, which are incorporated into this specification, illustrate one or more exemplary embodiments of the inventions and, together with the detailed description, serve to explain the principles and applications of these inventions. The drawings and detailed description are illustrative, and are intended to facilitate an understanding of the inventions and their application without limiting the scope of the invention. The illustrative embodiments can be modified and adapted without departing from the spirit and scope of the inventions.

FIG. 1 is a block diagram of a system according to some embodiments of the invention.

FIG. 2A is a block diagram of a sensing device according to some embodiments of the invention.

FIG. 2B is a block diagram of a sensing device according to some embodiments of the invention.

FIG. 2C is a block diagram of a sensing device according to some embodiments of the invention.

FIG. 3 is a block diagram of an airplane having one or more sensing devices according to some embodiments of the invention.

FIG. 4 is a block diagram of an oil rig and oil pipeline having one or more sensing devices according to some embodiments of the invention.

FIG. 5 is a block diagram of a wind turbine having one or more sensing devices according to some embodiments of the invention.

FIG. 6 is a block diagram of a strain sensing element of a sensing device according to some embodiments of the invention.

### DETAILED DESCRIPTION OF PREFERRED EMBODIMENTS

The present invention is directed to systems and methods for monitoring the structural and/or environmental conditions of one or more objects. The object can be a machine, such as a vehicle. The object can be a structure, such as building or a bridge. The object can be an electro-mechanical device or system that includes a control system for controlling moving components such as wind turbine, an oil rig, a solar collector, a tram, a ski lift, an elevator or an escalator. In accordance with some embodiments of the invention, the system can include on or more sensing devices affixed or mounted to the object to sense one or more conditions of the object or a component of the object. In accordance with some embodiments, the sensing devices can be removably affixed to the object (or a portion thereof) with a removable adhesive that enables the sensing device to be replaced, repaired and/or reused. In accordance with some embodiments of the invention, the sensing devices can be permanently mounted to the object (or a portion thereof) such that the sensing devices can remain intact under extreme conditions and/or removal would cause substantial damage to the object.

In accordance with some embodiments of the invention, the sensed condition information can be used to modify the operation of the system (e.g., a device or set of devices), for example, to cause a computer program, function or process to be executed or to change the flow of an executing program, function or process. In one example, a motion sensor (e.g., an accelerometer) could detect one or more motion characteristics (e.g., vibration, direction, velocity or acceleration) of the object and as a result, the system could cause a monitoring computer program, function or process to be executed to measure stress or strain experienced by the object or a portion of the object. The stress or strain data or a command determined as a function of the stress or strain data can be sent to the control system of the object to cause a change in the operation of the control system or the operation of the object. For example, a high stress value can sent to the control system to cause the system to shut down or go into a mode to reduce the effects of the stress. Alternatively, the hub can send a shutdown command or mode change command that is determined when the stress or strain values exceed a predefined threshold. The object can be fitted with more than one sensing device and each sensing device can measure the motion, stress and/or strain at a different location on the object. The sensor data can be collected and analyzed either by the hub or the control system, and used to control systems that operate within the object or interact with the object.

In accordance with some embodiments of the invention, the sensed condition information can be used to modify the operation of the system (e.g., a device or set of devices), for example, to cause other sensors to be activated so that their data can be used as part of newly started or an ongoing computer program, function or process for monitoring the object. In one example, a temperature sensor could detect a rise in the object's temperature (e.g., above threshold or steady state temperature) and as a result, the system could activate other sensors to monitor other aspects of the object or the object's environment. Similarly, the rise in temperature above the designated threshold could trigger a system within the object (e.g. a cooling system) or external to the objection to start, end or change its operation.

In accordance with some embodiments of the invention, the sensed condition information can be used to cause the system (e.g., a device or set of devices) to communicate with one or more other systems (e.g., control systems of an object being monitored by the sensing devices.), resulting in a change in operation of these other systems or the actuating devices (e.g., motors, transducers, servos, actuators) that they control. For example, the system can send a signal (e.g., wired or wireless) to a control system and the signal can cause the control system to change its operation or the operation of a system under its control (e.g. wind velocity could be used to control a motor or actuator that adjusts the angle of attack of blades of a wind turbine). In another example, the system can detect a temperature change (a drop or an increase) in the object and the system can send a signal to a control system and the control system can cause a heating or cooling system to turn on (or off) and/or raise/lower the temperature in the environment.

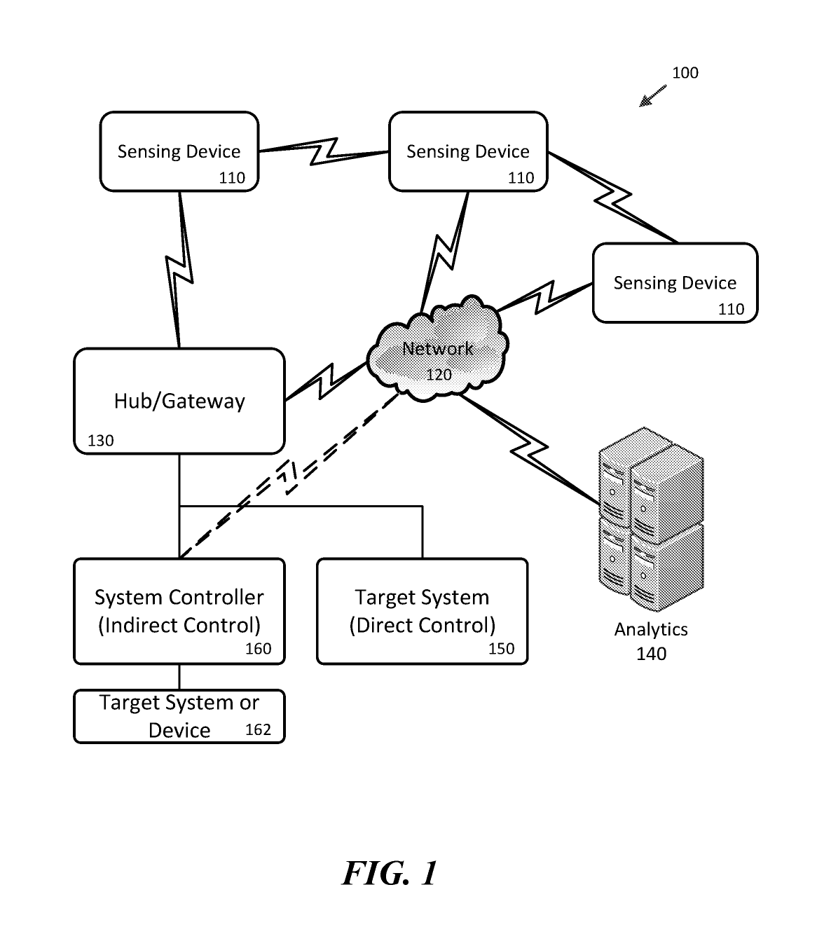

FIG. 1 shows an example of a system 100 according to some embodiments of the invention. In this embodiment, the system 100 can include one or more sensing devices 110, a hub or gateway 130, and target device 150 and/or controller 160. An optional analytics system 140 can also be connected to the system 100. The controller 160 can be connected to and used to control a target device 162, indirectly.

The sensing device 110 can be any device capable of detecting or measuring physical, mechanical or electrical characteristics of the object and more than one sensing device can be included in the system 100. Each sensing device 110 can be configured with one or more controllers or microcontrollers, such as a low power system on a chip microcontroller, associated memory and a power source, such as a battery. The controller can be configured to run one or more digital signal processing algorithms and/or raw data signal processing algorithms. Each sensing device 110 can include one or more sensors such as accelerometers, gyroscopes, temperature sensors, light sensors (e.g., visible and invisible light), sound or vibration sensors, electrodes (e.g., measure electrical signals and impedances), stress sensors, strain gauge sensors, and other sensors. Each sensing device 110 can be configured to send sensor data to the hub or gateway 130. The sensor data can include raw sensor signal data, processed sensor signal data (e.g. filtered, scaled, segmented), signal features (e.g. dominant frequency, range, root mean square value) and algorithm output (e.g. over/under temperature detection or alarm, failure detection, shock/vibration alarm, stress/strain detection, and/or leak detection). The sensor data can include other information, such as metadata (e.g., information about the sensor device, the date, the time, the type and the scale or units of the sensor data).

Some examples of sensors and types of sensor data include, but are not limited to, electrodes and electrode arrays for measuring electrical signals and impedances at the location where the sensor is affixed or mounted to the object or between locations where two or more sensors are affixed or mounted to the object. Stress and strain gauges can be included for measuring stress and/or strain at the location where the electrode is affixed or mounted. Piezoelectric sensors and actuators for mechanical energy harvesting and pulse and/or waveform measurements. Temperature sensors, such as thermal couples and thermistors (for measuring core and surface temperature, environmental temperature, and heat flux of the object), imaging and optical sensors and/or photodetectors (for ultraviolet, visible light analysis, and/or colorimetry analysis), pH sensor (e.g., environmental conditions), analyte sensor (e.g. chemical composition of fluids inside and outside of a pipe or structure), chemical/gas sensor (chemical composition of fluids inside and outside of a pipe or structure, such as, pollutants, deadly gases, mercury). Other sensor data can include derivative sensor data derived (e.g., derivative data) from the raw sensor data over time or frequency.

The processed sensor data can be derived from the raw sensor data by various well known processes to remove noise or to characterize sets or units of raw sensor data (e.g., into features, tokens and/or messages). The sensing device 110 can include a processor and associated memory and execute one or more computer programs that collect sensor data on a continuous or periodic basis. The sensing device 110 can include a communication system that enables the raw sensor data or the processed sensor data to be transmitted to a remote device or system, such as the hub or gateway 130. The communication system can be adapted to provide wired or wireless communication with a remote device, such as the hub or gateway 130. In accordance with some embodiments of the invention, wireless communication can include communications traveling through the structure of object that the sensing devices 110 are attached or mounted to, such as the metal skin of an airplane, the metal structure of an oil rig or the metal structure of a wind turbine.

Each sensing device 110 can take many forms, including, for example, a flexible or stretchable conformable sensing device that can be adhered to the surface of the object, a belt or strap that can be used to secure the sensor to the object, sensor can be incorporated in a cover, covering or coating on the object (e.g., the surface of the object) or a pad or plate that can be mount in or on the object. In accordance with some embodiments, the sensing device 110 can be affixed to the object using an adhesive (e.g., a pressure sensitive adhesive) the enables the sensing device 110 to be removed to be replaced, repaired or reused. In accordance with some embodiments, the adhesive used to affix the sensing device 110 to the object can be removable and/or replaceable. In accordance with some embodiments, the sensing device 110 can be permanently mounted to the object using a permanent adhesive (e.g., epoxy), making removal more difficult, but enabling the sensing device 110 to remain attached during very active and aggressive activities and environments. In accordance with some embodiments, the sensing device 110 can be permanently mounted to the object by moulding, soldering, brazing or welding, making removal more difficult, but enabling the sensing device 110 to remain attached during very active and aggressive activities and environments. The sensing device 110 can detect and measure the physical motion, impact and/or vibration experienced by the object. The sensing device 110 can detect and measure ambient environmental temperature as well as the temperature of the object (e.g., core temperature, surface temperature and heat flux). The sensing device 110 can detect and measure impacts to the object, stress and strain experienced by the object, changes in surface impedance of the object, and electrical activity of the object. The sensing device can detect and measure electrical potentials, stress and strain, surface temperature, core temperature, heat flux, salt concentrations in water, surface potentials (e.g. corrosion rates), pH levels (e.g., of fluid in or flowing through an object or outside the object), visible/infrared/ultraviolet radiation exposure, contact pressure, barometric pressure, object and/or surface strain, images of sub-surface structures using ultrasound transducers from the object. The sensing device can contain actuators to deliver electric current (electric fields) to the object or a portion of the object, LED arrays (e.g., UV, blue and near infrared light) to deliver broad or narrow spectrum for imaging or treating the object or a portion of the object.

The sensing device 110 can sample the output of one or more sensors on a periodic basis (e.g., at 1 Hz, 5 Hz, 10 Hz, 60 Hz, or more) and, optionally, convert the signals into digital data. The digital data can be buffered, stored and streamed to one or more remote devices, such as the hub or gateway 130 or another sensing device 110. In accordance with some embodiments, the sensing device 110 can be connected by wire or wirelessly to other sensing devices, for example, to transfer data to the hub or gateway 130 or through a network 120 to other remote devices. In accordance with some embodiments of the invention, the sensing devices 110 can form a mesh network 120 for transmitting data between the devices 110 and the hub or gateway 130 and/or an analytics system 140.

In accordance with some embodiments, the hub or gateway 130 can be an interface that connects one or more sensing devices 110 to a target system 150, a system controller 160, and/or an analytics system 140. In accordance with some embodiments, the hub or gateway 130 can include one or more processors and associated memory and execute one or more computer programs, functions or processes to receive, store, process and/or analyze sensor data from the sensing devices 110. In accordance with some embodiments, the analysis can include executing rules or comparing sensed values to threshold values and reporting the data as a function of the rule outcome or the comparison result. In accordance with some embodiments, the hub or gateway 130 can be configured to send an alert or a command to a remote system causing the system to change its operation.

The hub or gateway 130 can be a computerized device (e.g., a system on a chip, a Raspberry Pi (Raspberry Pi Foundation, Cambridge, UK), an Arduino (Somerville, Mass.), Windows or Linux compatible computers). The hub or gateway 130 can be configured to communicate with the sensing device 110 using any wired or wireless communication band (e.g., Bluetooth, WiFi, ZigBee, WMTS, cellular data, and industrial, scientific, and medical (ISM) band communications). The sensor device 110 and the hub or gateway 130 can use an industry standard communication protocol or a proprietary communication protocol. The hub or gateway 130 can include a processor and associated memory that can receive the raw sensor data or the processed sensor data from the sensing device 110 and store it in memory for further processing or for communication to a remote system for further processing, such as analytics system 140. The hub or gateway 130 can include one or more sensors (e.g., accelerometer, GPS, temperature, light). The hub or gateway 130 can include a network interface (e.g., wired such as Ethernet or wireless such as WiFi or 3G, 4G, 4G LTE mobile data) that enables the hub or gateway 130 to communicate other hubs, gateways, computers, and systems, such as analytics system 140 and other sources of data and information (e.g., the Internet). In accordance with the invention, the hub or gateway 130 and/or the analytics system 140 can further analyze the sensor data using analytics algorithms that either process and/or analyze the sensor data by itself or in combination with other available data (e.g., historic data or third party data). For example, the gateway 130 or analytics system 140 can analyze the sensor data to detect an out of range condition, such as a sensor data value that is either above or below a predefined threshold. In accordance with some embodiments, the out of range condition can be determined as a function of one or more sensor data values and optionally other data (e.g., stored data, remote data such as weather data or factual data). In accordance with some embodiments of the invention, the hub or gateway 130 can analyze the sensor data and as a function of at least the sensor data, directly communicate with another device to control that device. For example, the hub or gateway 130 can receive sensor data (either from the sensing device 110, its own internal sensor, or both) indicating the level of illumination in an environment and as a function of the sensed illumination data, directly turn on or off other sensing devices 110 or other sensors in itself or other sensing devices 110.

In accordance with some embodiments of the invention, the hub or gateway 130 can analyze the sensor data and as a function of at least the sensor data, indirectly communicate with another device through an interface, such as separate control system 160 in order to control that device 162. For example, the hub or gateway 130 can receive sensor data indicating the ambient temperature level in an environment, such as the water around a sub-sea pipeline, and as a function of the sensed temperature data, directly control the heating and/or cooling (e.g., turn the heating and/or cooling system on or off, or adjust the thermostat set-point temperature up or down) of the fluid in the pipeline, such as to optimize flow rates.

In accordance with some embodiments of the invention, the hub or gateway 130 can send the raw sensor data or the processed sensor data (or both) to a remote analytics system 140 that can process and analyze the sensor data and the analytics system 140 can communicate directly or indirectly with other devices 150, 162 to control them and the environment.

In accordance with some embodiments of the invention, the hub or gateway 130 together with remote analytics system 140 can process and/or analyze the raw or processed sensor data, optionally in combination with other data from other sensors or stored data, weather data, or date and time information, to determine one or more actions. The actions can include communicating with a target device 150 to control it directly or communicating with a remote controller 160 that controls the target device 162. For example, using weather and water activity data (e.g., flow and vibration), the hub or gateway 130 and/or the analytics system 140 can control one or more valves on an oil rig to reduce the risk of an oil spill in the event of an approaching storm.

In accordance with some embodiments, the analytics functionality can be distributed over a one or more hubs or gateways 130 in a network or cluster configuration to form a distributed processing system to provide for distributed processing of the sensor and, optionally, other data. In accordance with some embodiments, the analytics functionality can be distributed over the hub or gateway 130 and one or more computer systems or clusters (e.g., other hubs or gateways 130, and/or analytics computer systems 140), in a distributed network or cluster system configuration to provide for distributed processing of the sensor and, optionally, other data. Each of the computer systems that make up the cluster can communicate using wired cluster interconnect technologies and/or wireless communication technologies (e.g., Ethernet, WiFi, mobile data, such as, GSM, 3G, 4G, and 4G LTE) or other network communication technologies. The network can include networking equipment, such as, one or more wires, switches, hubs, wireless access points, and routers to enable communication between the devices and systems.

In accordance with some embodiments of the invention, the hub or gateway 130 can be configured to communicate directly with one or more target devices 150 using wired or wireless communication (e.g., infrared, Ethernet, Bluetooth classic, Bluetooth low energy WiFi, ZigBee, WMTS, cellular data, GSM, 3G, 4G, and industrial, scientific, and medical (ISM) band communications). In accordance with some embodiments of the invention, the hub or gateway 130 can be configured to communicate directly with one or more controllers 160, using wired or wireless communication (e.g., infrared, Ethernet, Bluetooth classic, Bluetooth low energy, WiFi, ZigBee, WMTS, cellular data, and industrial, scientific, and medical (ISM) band communications). The controllers 160 can be controlled using an open or proprietary interface or an application programming interface (API) to control the target device 162.

The analytics system 140 can include one or more computers (e.g., processors and associated memory) that are configured to receive the sensing data. The sensing data can be transmitted by the hub or gateway 130 to the analytics system 140 over a public or private network. In accordance with some embodiments, the hub 130 acts a gateway that forwards the sensor data to the analytics system 140 according to predefined instructions or configuration. The analytics system 140 can be, for example, a cloud server or a big data server (e.g., based on Hadoop, or another analytics engine) that can receive, store and analyze the sensor data according to a predefined analytical method or process. In accordance with some embodiments, as a result of the predefined analytical method or process, the analytics system 140 can generate one or more commands and/or data and send one or more of those commands and/or data to the hub or gateway 130, a target device 150 or a controller 160. The commands can be used to control or change the operation of the hub or gateway 130, a target device 150 or a controller 160.

In accordance with some embodiments, the hub or gateway 130 can send one or more commands (e.g., an instruction to do something or perform some function or operation, or an acknowledgement that a function or operation has started or completed) and/or data (e.g., sensor data, user data, and environmental data) to the analytics system 140. The analytics system 140 can interpret and respond to the commands, for example, to retrieve data or process data or change the way the analytics system 140 processes the data. The response can include a command (e.g., an acknowledgement or instruction) and/or data (e.g., data or information requested, results of an analysis or other sensor data). The hub or gateway 130 can use the data for further analysis by algorithms on the hub or gateway 130 or to determine whether one or more commands and/or data should be sent to a target device 150 or a controller 160.

In accordance with some embodiments of the invention, the target device 150 can include a device that can communicate directly with the hub or gateway 130. Thus, the target device could be, for example, a valve, a motor or servo, relay, a door lock, a manned or unmanned motorized vehicle (e.g., a drone or crawler), a computer, a programmable controller, a sound system, an environmental control system (e.g., heating system, or cooling system), a home automation system, and a communication system (e.g., voice/telephone, text messaging, email, facsimile, and chat). In accordance with some embodiments of the invention, the target controller 160 can be, for example, a home automation controller (e.g., to control target devices 162, such as lights, HVAC, garage doors, door locks, appliances, and sound systems), an HVAC controller (e.g., thermostat), home entertainment system, a dispatch system (e.g., dispatching motorized vehicles, people and/or services), and a motor vehicle control system (e.g., controlling vehicle operation, including direction and navigation, safety, and vehicle environmental control).

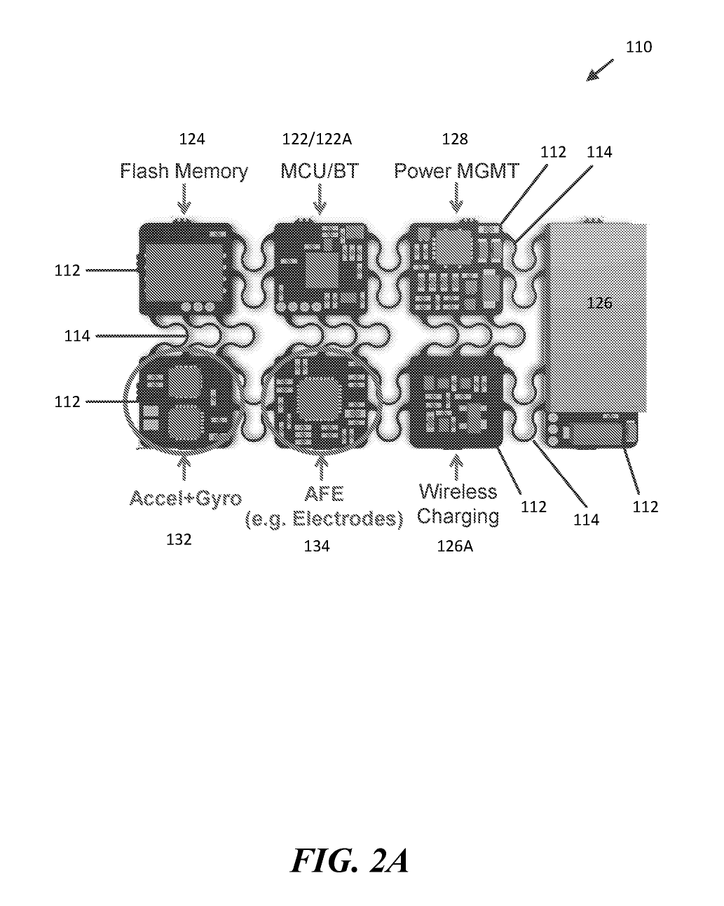

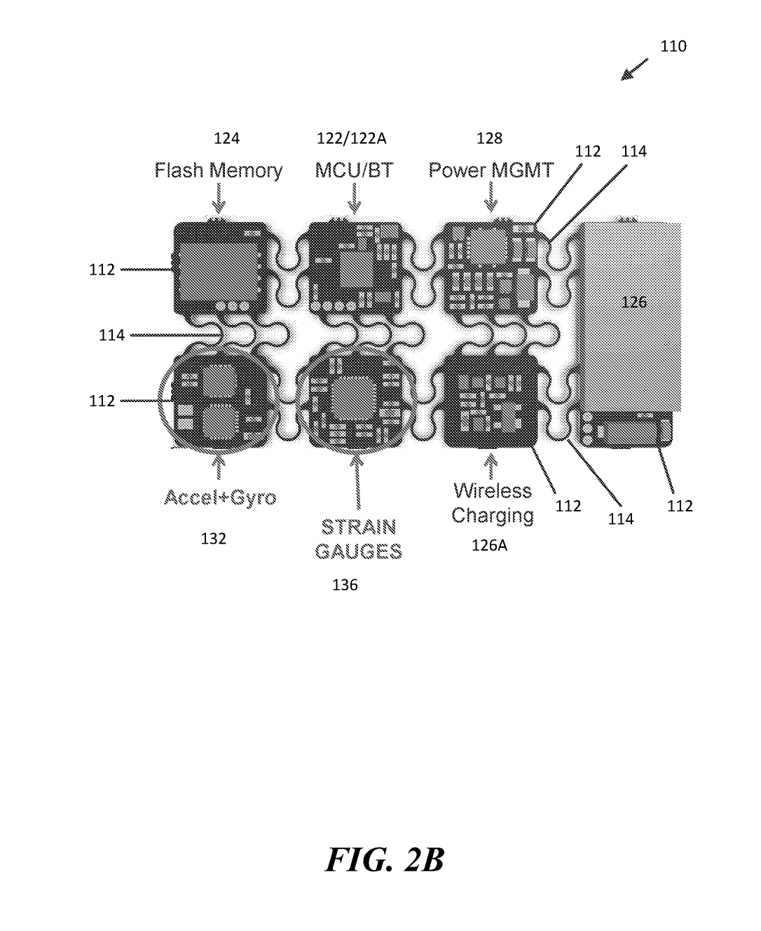

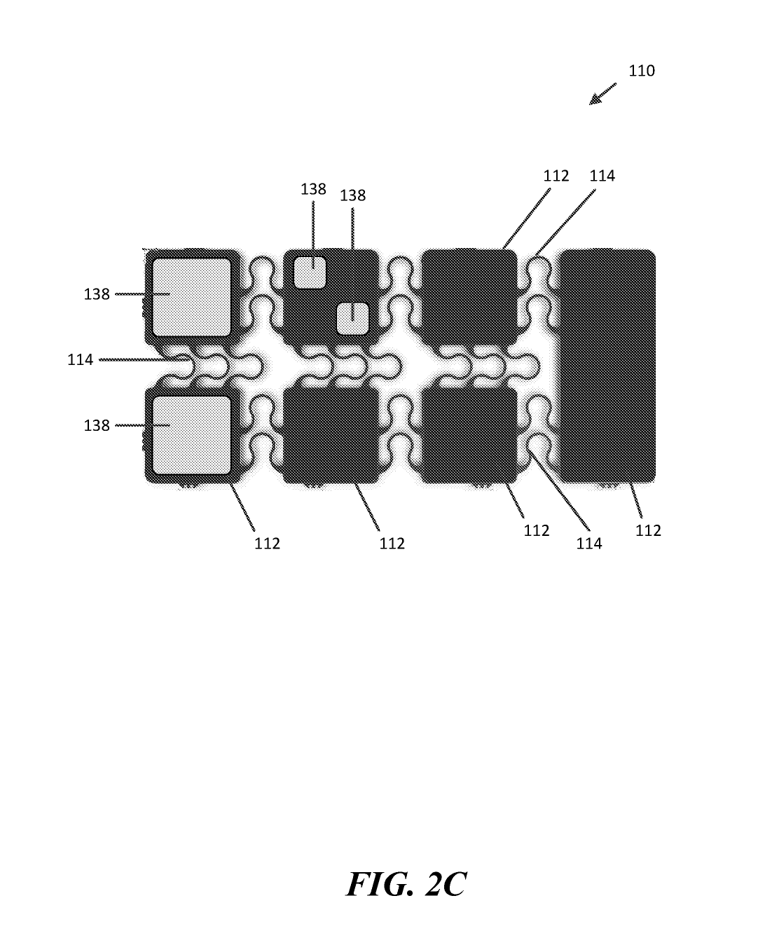

FIGS. 2A-2C show diagrammatic views of a sensing device according to some embodiments of the invention. The sensing device 110 can be flexible, such as, including a flexible printed circuit board, to enable it to conform to irregular surfaces, as well as flex when the object flexes or deforms during use.

FIGS. 2A-2C show diagrammatic views of some embodiments of a sensing device 110 according to the invention. In accordance with some embodiments of the invention, the sensing device 110 can include a plurality of components mounted on device islands 112 wherein each device island 112 can be connected to an adjacent device island 112 by one or more flexible and or stretchable interconnects 114, enabling the sensing device to flex and/or stretch and conform to irregular surfaces, such as those of irregularly shaped objects, without inhibiting the electrical operation of the sensing device 110 (e.g., the flexible interconnects remain operative while flexed or stretched). The sensing device 110 can be encapsulated in a flexible or stretchable material, such as, silicone or PDMS or a rigid protecture material (e.g., a polymer material, expoxy based material, a ceramic or metal based material). The sensing device 110 can include an adhesive material that enables the sensing device to adhere to the interior or exterior surface of an object. The sensing device 110 can optionally include one or more user interface components, such as buttons, lights (e.g., LEDs), displays, speakers or vibrators that enable a user to interact with the device using visual, audible and sensory cues. These user interface components can be used to provide operational, configuration, and performance feedback to a user directly, such as, through visual and tactile output capabilities via LEDs and vibration motors.

As shown in FIGS. 2A-2C, the sensing device 110 can include a processor 122 and associated memory 124 and a battery 126 which serves as a power source and a power management controller 128. A wireless charging interface 126A can be used to charge the battery 126. The sensing device 110 can include one or more sensors, including an accelerometer and/or gyro 132, electrical sensing components 134, electrodes 138 and one or more strain gauges 136. The sensing device 110 can also include wireless transceiver 122A (e.g., such as Bluetooth ™, WiFi, mobile data) and an antenna to enable the sensing device 110 to communicate with other sensing devices 110, a hub or gateway 130 or other systems.

In accordance with some embodiments, the memory 124 can store one or more computer programs, including an operating system (e.g., Linux) as well as one or more application programs, functions and processes that can be used to control the operation of the sensing device 110. One or more programs, functions or processes can be used to collect accelerometer data, which includes motion and acceleration information in 1, 2 or 3 dimensions as well as temperature data. One or more programs, functions or processes can be used to collect electrical potentials and impedances the electrodes 138 and associated electrical sensors 134. The electrical potential and impedance data can include data representative of at least one of the following signals: surface and environmental electric potentials (e.g., of the object or the object's environment such as surrounding water), depending on how the one or more programs, functions or configures the electrical sensor 115. The sensing device 110 can include one or more electrodes 138 that can be placed in contact with the object or the surrounding environment of the object to receive these signals. In accordance with some embodiments of the invention, the electrical potential or impedance data can be used to determine corrosion rates and detect environmental conditions harmful to the object.

In operation, the sensing device 110 can be configured using one or more programs, functions or processes to collect raw sensor data and store the data in memory 112. In accordance with some embodiments, one or more programs, functions or processes running on the processor 122 can process and/or analyze the raw sensor data and generate processed sensor data, for example, by filtering the raw data to remove noise and/or artifacts and/or to normalize the raw sensor data. In accordance with some embodiments, the raw sensor data and/or the processed sensor date can be further processed by computing descriptive analytics (e.g., minimum values, maximum values, mean values, median values, mode values, standard deviation and variance values, and higher moments such as kurtosis) on one or more sets of samples of the data, and comparing such values against the comparable values of a larger cohort of relevant objects, or against prior measurements collected on the same object. In accordance with some embodiments, the raw sensor data or the processed sensor data can be further processed to extract specific features or characteristics of the signal like the dominant frequency, range, root mean square value, correlation coefficient, etc. The features can be further processed using one or more algorithms (e.g. decision tree, state machine, and/or linear/logistic regression) to detect or predict events (e.g. system or component failures, leaks, stress and strain related events, impact related events) or to detect or predict status (e.g., object performance, object maintenance, component replacement). In accordance with some embodiments, the raw sensor data can be converted to tokens or symbols representative of two or more raw sensor data values. The raw sensor data can be processed in real time as it is received from the sensor element or it can be processed in blocks after a predefined number of raw sensor data values are received. The raw data and the processed data can be stored in memory 124, until it is transmitted to a remote device.

The sensing device 110 can process the data to generate one or more higher order metrics, by processing the raw data to determine, for example, event type detection, object-specific or location-specific performance indicators, and sensor quality. The sensing device 110 can receive and process external commands which cause the device to modify its configuration and/or operation for collection, processing, and reporting of sensor data, including turning on or off various sensor combinations, changing sampling rates and measurement ranges, modifying buffering and filtering schemes, and applying different digital signal processing and algorithms to raw sensor output to produce different streams of data and/or different sets of higher order biometrics around activity tracking, activity performance, and activity quality data. Based on the metrics determined and/or other data, the sensing device 110 can, based on an algorithm or set of rules, select a sensing modality which is optimal for a particular monitoring mode or location that has been detected, and automatically modify its configuration and/or operation for collection, processing, and reporting of sensor data, including turning on or off various sensor combinations, changing sampling rates and measurement ranges, modifying buffering and filtering schemes, and applying different digital signal processing and algorithms to raw sensor output to produce different streams of data and/or different sets of higher order biometrics around activity tracking, activity performance, and activity quality data.

In accordance to some embodiments of the invention, when the sensing device 110 is connected using, for example, the wireless transceiver 122A (e.g., Bluetooth ™, WiFi or Zigbee) to the hub or gateway 130, the raw sensor data and/or the processed sensor data can be transmitted using the wireless transceiver 122A to the hub or gateway 130 and stored in the memory of the hub or gateway 130. In accordance with some embodiments of the invention, the sensor data can be transmitted by the hub or gateway 130 to the analytics system 140 for long-term storage and further analysis.

The system 100 can be configured to enable many different data flows. In accordance with some embodiments of the invention, the raw data or processed sensor data (metrics) can flow from the sensing device 110, through the hub or gateway 130 to the analytics system 140 or a the data storage system associated with the analytics system 140. The sensor data (e.g., raw or processed) can be pre-filtered, conditioned, manipulated, or combined with other data within the hub or gateway 130. The sensor data (e.g., raw or processed) can also be filtered, conditioned, manipulated, or combined with other data within the data storage and analytics system 140, and can be used to tune the operation of the individual sensing devices 110 as well as the hub or gateway 130.

In accordance with some embodiments of the invention, processed sensor data or other data can flow from the data storage and analytics system 140 through the hub or gateway 130 and back to the sensing device 110. Processed data (e.g., commands, control instructions, or higher order information, such as, software and algorithms for system upgrades and updates) can flow from the data storage and analytics system 140 to the hub or gateway 130 and through the hub or gateway 130 or implantable device 170 to the sensing device 110. The data can be filtered, interpreted, validated, and/or combined with other data within the smart device. The data can also be filtered, interpreted, validated, and/or combined with other data within the sensing device 110.

In accordance with some embodiments of the invention, the raw data or processed sensor data (metrics) can flow from the sensing device 110 (optionally through the hub or gateway 130), through the data storage and analytics system 140 to one or more external systems, such as, machines, equipment, and environmental control systems. Processed data (commands, control instructions, or higher order information, such as, software and algorithms for system upgrades and updates) can flow from the data storage and analytics system 140 to external machines or equipment (e.g., exercise equipment, power tools, motorized vehicles) and/or environmental control systems (such as ambient temperature control system, lighting, or alerting and alarm systems). The data can be filtered, interpreted, validated, and/or combined with other data within the external machine, equipment or environmental control system. The data can also be filtered, interpreted, validated, and/or combined with other data within the sensing device 110.

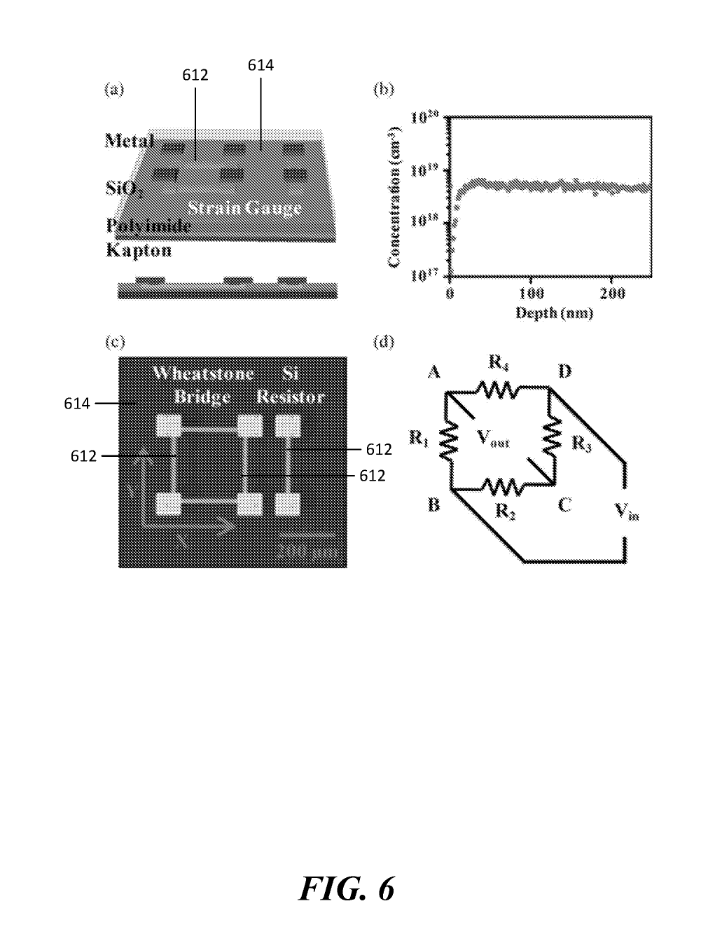

FIG. 6 shows a diagrammatic view of how a strain gauge can be incorporated in a device island 112 of a sensing device 110 according to some embodiments of the invention. The strain gauge can include microstructured silicon ribbons or membranes 612 mounted to a flexible or stretchable substrate 614 and arranged in a Wheatstone bridge configuration, FIGS. 6(c) and 6(d). The microstructured silicon ribbon functions as resistor that changes with elongation. The microstructured silicon ribbon can be doped with boron to reduce its temperature dependent response to stretching while maintaining it longitudinal piezoresistance. These strain sensors are described in Won, et al., Piezoresistive Strain Sensors and Multiplexed Arrays Using Assemblies of Single-Crystalline Silicon Nanoribbons on Plastic Substrates, IEEE Transactions On Electron Devices, Vol. 58, No. 11, pp. 4074-78, November 2011, which is hereby incorporated by reference in its entirety.

### Applications

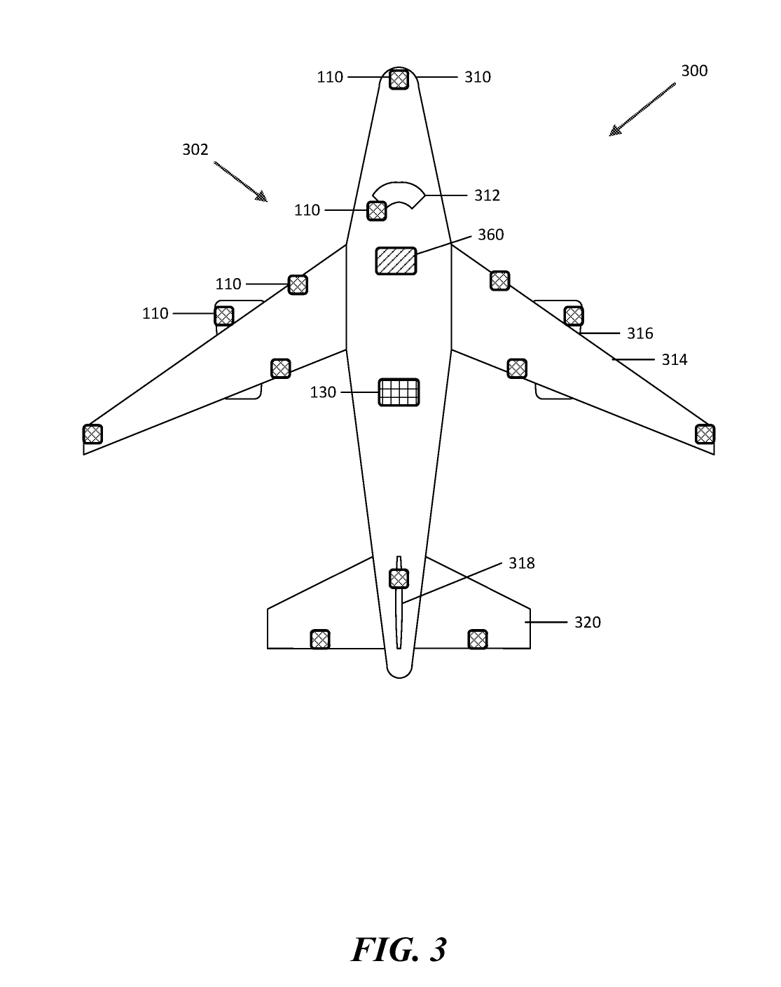

FIGS. 3-5 show examples of objects that can be monitored and controlled using the system of FIGS. 1-2C.

FIG. 3 shows a diagrammatic view of a monitoring system 300 for monitoring various aspects of an airplane 302. The sensing devices 110 can be removably affixed or permanently mounted to the external or internal surfaces of nose cone 310, windshield 312, landing gear, engine 316, the wings 314 (e.g., leading edges and/or control surfaces), tail 318 (e.g., the leading edge and/or control surface) and the rear wings 320 (e.g., leading edges and/or control surfaces). One or more gateways 130 can be installed throughout the airplane to collect the sensor data from the sensing devices 110. The gateway 130 can be connected to the control or instrumentation system 360 of the airplane 302 to report sensed information and conditions to the pilots. Alternatively, the gateway 130 can store the data (e.g. locally in local memory or remotely in a remote storage device) and enable maintenance personnel to access the data after landing for flight check and maintenance purposes. For example, a strain gauge sensor can measure stress and or strain on landing gear and indicate a fatigue condition based on strain based deformation or the number of use cycles (e.g., landings and/or take-offs).

In accordance with some embodiments of the invention, the sensing devices 110 can be attached to tires of a racing car, ultra-high-speed drill bits, tips of gear teeth and the like. Therefore, design and manufacturing of such components involving high impact points may require extremely sharp analysis and monitoring of forces and other parameters. Therefore, surface monitoring devices or layers or films can be embedded or disposed with stretchable electronics components that can tolerate high impacts and can deform based on physical and environmental conditions. Further, these high impact devices can be provided with stretchable and/or flexible electronics enabled sensing devices and layers for operations monitoring purposes as well. In accordance with some embodiments, the stretchable electronics component can deform at high impact points upon an application of large forces such as dynamic or sliding friction, rolling resistance, wheel spinning force and the like to withstand the effect of high impacts and continue to function as expected. In addition, data storing devices mounted at high impact points can also utilize stretchable electronics component that can deform in shape under severe conditions for proper monitoring and data storing without failure.

In accordance with various embodiments, stretchable electronics component can be utilized in automated manufacturing environments to create a failure proof environment. In a conventional manufacturing environment, several electronics modules can be used for monitoring, sensing, inspection and the like purposes. These electronics modules may be prone to severe conditions and fracture, crack or fail easily on account of the harsh conditions. Therefore, stretchable electronics enabled modules can be used and configured to deform in shape to tolerate severe manufacturing conditions. For example, these stretchable electronics component can be associated with tactile sensor arrays that may be mounted on a robotic vehicle/arm/linkage or mechanism and the like.

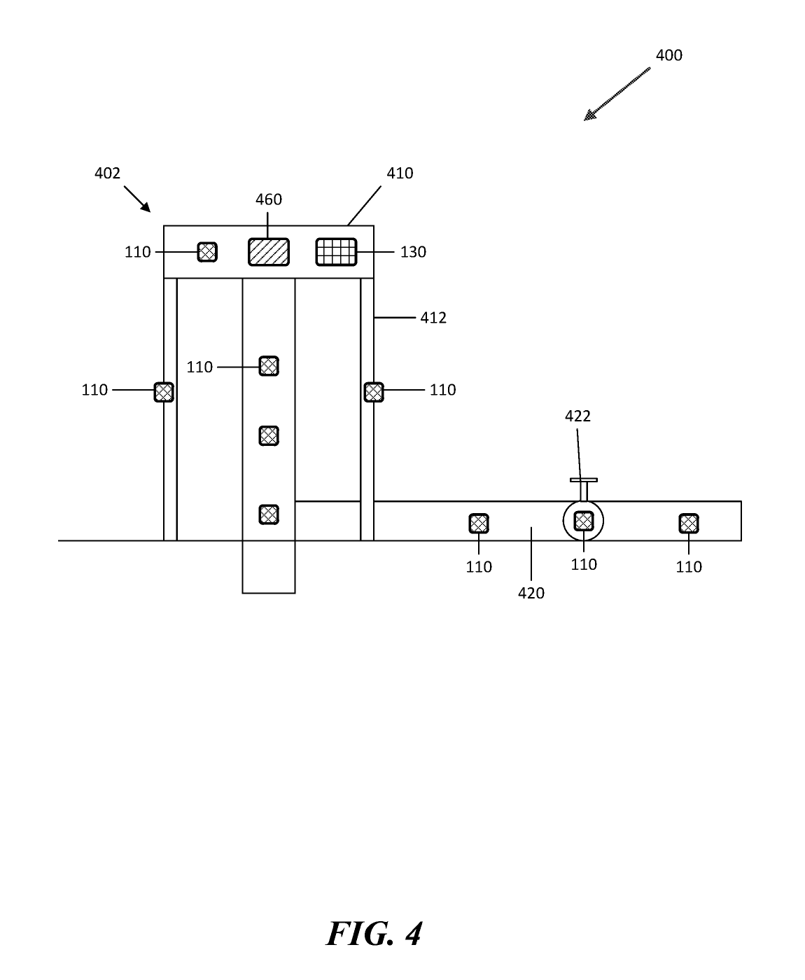

FIG. 4 shows a diagrammatic view of a monitoring system 400 for monitoring various aspects of an oil rig 402 and underwater pipeline 420. The sensing devices 110 can be removably affixed or permanently mounted to the external or internal surfaces of the oil rig 402 and the pipeline 420, including the structural supports 412, the drilling platform 410, the pipeline 420 and one or more valves 422 of the pipeline. One or more gateways 130 can be installed throughout the oil rig and/or the pipeline to collect the sensor data from the sensing devices 110. The gateway 130 can be connected to the control system 460 of the oil rig 402 to report sensed information and conditions of the rig 402 and the pipeline 420 to the rig operator. Alternatively, the gateway 130 can store the data (e.g. locally in local memory or remotely in a remote storage device) and enable maintenance personnel to access the data remotely for system monitoring and maintenance purposes. For example, a strain gauge sensor can measure stress and or strain on the structural supports 412 or the pipeline 420 and indicate a fatigue condition (e.g., platform failure or pipeline leak) based on strain based deformation. The sensing devices 110 can monitor fluid flow inside the pipeline and detect a change inflow speed, indicating a blockage (e.g., reduction inflow) or leak (e.g., increase inflow).

In accordance with some embodiments, the gateway 130 can be mounted to movable vehicle, such as a drone or pipe crawler that travels through the pipeline 420 or around the outside of the pipeline 420 and collects data from the sensing devices 110 using wireless technologies (e.g., WiFi, BlueTooth, BlueTooth Low Energy, Near Field Communication, Radio Frequency ID). The data can be collected periodically or episodically from predefined sets of one or more sensing devices 110. The data can be process and analyzed by the mobile gateway 130 and forwarded to a control system 160 for action or an analytics system 140 for further analysis.

In accordance with some embodiments, the pipeline can be an overland type pipeline (e.g., a water, gas, oil, or sewage pipeline).

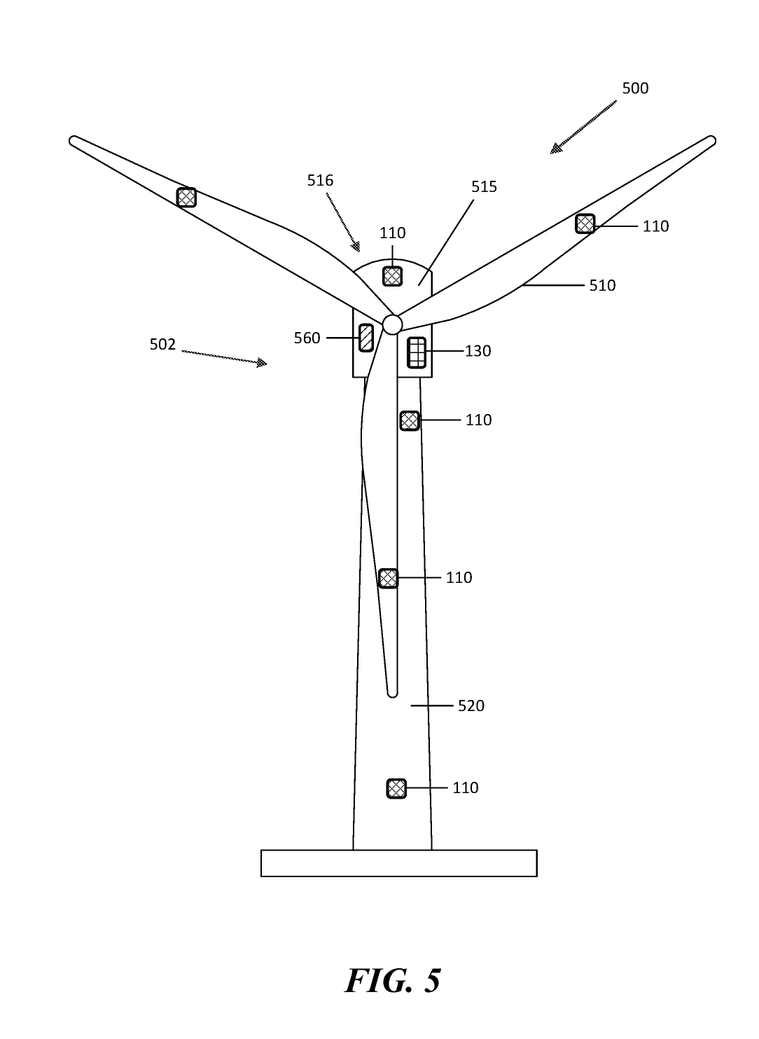

FIG. 5 shows a diagrammatic view of a monitoring system 500 for monitoring various aspects of a wind turbine 502. The sensing devices 110 can be removably affixed or permanently mounted to the external or internal surfaces of the wind turbine, including the generator housing 515 and turbine blades 510, and the support post 520. One or more gateways 130 can be installed throughout the wind turbine to collect the sensor data from the sensing devices 110. The gateway 130 can be connected to the control system 560 of the wind turbine 500 to report sensed information and conditions of the wind turbine generator 516, turbine blade 510 and support structure 520 to the wind turbine operator. Alternatively, the gateway 130 can store the data (e.g. locally in local memory or remotely in a remote storage device) and enable maintenance personnel to access the data remotely for system monitoring and maintenance purposes. For example, a strain gauge sensor can measure stress and or strain on structural supports and indicate a fatigue condition based on strain based deformation. The sensing devices 110 can monitor wind speed can send wind speed information to the turbine control system to adjust the angle of attack of the turbine blades to reduce the stresses of high winds on the turbine blades and restore the angle of attack as the wind speeds drop below a predefined threshold.

Since the components of the wind turbine are exposed to extreme pressure, sensing devices fabricated with stretchable electronics component can offer advantages of being stretched when exposed to high wind pressure and may regain their original shape once these conditions disappear. In accordance with some embodiments, stretchable electronics can be integrated into various sensing devices and used to monitor wind speed, wind direction, moisture content and the like. Further, the stretchable electronic circuitry such as devices, components, modules, sensors and the like can be utilized for assessing the structural health of various parts of the wind turbine. For example, the self-powered stretchable electronic component may be utilized to determine the structural health of the blades of the wind turbine. Similarly, the wear and tear of a wind turbine shaft can be evaluated using one or more stretchable electronics sensing devices; the stretchable electronics component can stretch and/or deform or expand along with the wear and tear of the wind turbine shaft and transmit data about its structural health.

In accordance with some embodiments, one or more types of imaging and sensing layers, systems and arrays may be positioned inside deep boreholes such as during drilling operations that can sense information and capture images relevant to functional and operational parameters of the drilling equipment such as bore width, bore depth, cutting rate, and the like and nature of soil such as water content, porosity of the soil, oil content and the like, and transmit the information and images to a computer or server for further utilization and planning. In addition, various control electronics modules having stretchable electronics components or stretchable electronics boards or any combination of these can be designed to control operational and functional parameters in an environment prone to stresses, vibrations, shocks, and other harsh physical conditions based on sensing and comparing sensed information with optimum levels.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system comprising:
a sensing device having at least one sensor configured to sense at least one condition of an object in an environment, the object including a control system configured to control a portion of the object;
an external hub in communication with the sensing device and configured to receive sensor data from the sensing device;
wherein the external hub is in communication with the control system to send at least one of sensor data or commands to the control system and the at least one of sensor data or commands causing a change in an operation of the control system.

2. The system according to claim 1 wherein the external hub includes a processor and associated memory, and one or more computer programs stored in the associated memory are executed by the processor to analyze sensor data to detect an out of range condition.

3. The system according to claim 2 wherein the out of range condition is determined as a function of at least one sensor data value.

4. The system according to claim 3 wherein the out of range condition includes a sensor data value above or below a predefined threshold.

5. The system according to claim 2 wherein upon detecting an out of range condition, the external hub communicates with a second sensing device causing the second sensing device begins sensing a second condition of the object.

6. The system according to claim 5 wherein the external hub receives sensor data about the second condition of the object and determines a second out of range condition as function of the sensor data about the second condition of the object.

7. The system according to claim 1 further comprising an analytics system connected to at least one of the sensing device and the external hub by a network and wherein the analytics system receives sensor data from at least one of the sensing device and the external hub.

8. The system according to claim 7 wherein the analytics system includes a processor and associated memory, and one or more computer programs stored in the associated memory are executed by the processor to analyze sensor data to detect an out of range condition.

9. The system according to claim 8 wherein the out of range condition includes a sensor data value above or below a predefined threshold.

10. The system according to claim 8 wherein upon detecting an out of range condition, the analytics system communicates with a second sensing device causing the second sensing device begin sensing a second condition of the object.

11. The system according to claim 1 wherein the sensing device includes an accelerometer configured for sensing motion of the object.

12. The system according to claim 11 wherein the sensor data is motion data and the motion data is sent to the control system causing a change in an operation of the control system.

13. The system according to claim 1 wherein the sensing device includes a strain gauge adapted for sensing strain of the object.

14. The system according to claim 13 wherein the sensor data is strain data and the strain data is sent to the control system causing a change in an operation of the control system.

15. The system according to claim 1 wherein the sensing device includes an electrode adapted for sensing electrical signals from the object.

16. The system according to claim 15 wherein the sensor data is electrical signal data and the electrical signal data is sent to the control system causing a change in an operation of the control system.

17. The system according to claim 1 wherein the sensing device includes a temperature sensor configured for sensing a measure of temperature of the object.

18. The system according to claim 17 wherein the sensor data is temperature data and the temperature data is sent to the control system causing a change in an operation of the control system.

19. The system according to claim 1 wherein the sensing device is a flexible sensing device.

20. The system according to claim 1 wherein the sensing device is a stretchable sensing device.

21. The system according to claim 1 wherein the external hub is in wireless communication with the sensing device.

22. The system according to claim 1 wherein the object is an airplane.

23. The system according to claim 22 wherein the control system is a flight control system of the airplane.

24. The system according to claim 1 wherein the object is an oil rig.

25. The system according to claim 24 wherein the control system is a control system of the oil rig.

26. The system according to claim 1 wherein the object is a wind turbine.

27. The system according to claim 26 wherein the control system is a control system of the wind turbine.
